(19) United States
(12) Patent Application Publication
(10) Pub. No.: US 2010/0323237 A1
(43) Pub. Date: Dec. 23, 2010

(54) BATTERY CONNECTOR COUPLING

(75) Inventors: Chi-Feng Huang, Linkou Township (TW); Jen-Chu Hsu, Taipei City (TW); Chih-Tsung Hu, Xizhi City (TW); Chung Jen Ho, Sinjhuang City (TW); Hao-Ming Chen, Taipei County (TW)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 12/486,386

(22) Filed: Jun. 17, 2009

(51) Int. Cl. H01M 2/00

(52) U.S. Cl. 429/163

(57) ABSTRACT

An information handling system (IHS) includes an IHS chassis having a processor and defining a battery housing. An IHS connector is located adjacent the battery housing and is electrically coupled to the processor. A battery is located in the battery housing and includes a battery chassis that houses at least one battery cell. A battery connector is electrically coupled to the at least one battery cell and engages the IHS connector. The battery connector is moveably coupled to the battery chassis through a battery connector coupling that allows the battery connector to move relative to the battery chassis when the battery connector engages the IHS connector.

### BACKGROUND

The present disclosure relates generally to information handling systems, and more particularly to a battery connector coupling for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Some IHSs such as, for example, portable or notebook IHSs, include batteries to provide power to the IHS. These batteries typically include a battery connector that couples to a connector on the IHS such that power stored in the battery can be provided to the IHS. The coupling of the connectors on the battery and the IHS can raise a number of issues.

For example, during shock/vibration events, the battery and IHS connectors can de-couple, which can result in the IHS powering down. Conventional solutions to this problem are to size the battery and IHS battery housing such that the battery fit in the IHS is tight, and may include adding latches or other structural components to ensure engagement of the connectors on the battery and the IHS to prevent their decoupling. However, such solutions run into space and design limitations as portable and notebook computers are designed smaller.

Accordingly, it would be desirable to provide an improved battery connector coupling.

### SUMMARY

According to one embodiment, an information handling system (IHS), includes an IHS chassis having a processor and defining a battery housing, an IHS connector located adjacent the battery housing and electrically coupled to the processor, a battery located in the battery housing and including a battery chassis that houses at least one battery cell, and a battery connector electrically coupled to the at least one battery cell and engaging the IHS connector, wherein the battery connector is moveably coupled to the battery chassis through a battery connector coupling that allows the battery connector to move relative to the battery chassis when the battery connector engages the IHS connector.

### BRIEF DESCRIPTION OF THE DRAWINGS

FIG. 1 is a schematic view illustrating an embodiment of an IHS.

FIG. 2 is a perspective view illustrating an embodiment of an IHS.

FIG. 3a is a perspective view illustrating an embodiment of a battery used with the IHS of FIG. 2.

FIG. 3b is a cut-away perspective view illustrating an embodiment of the battery of FIG. 3a.

FIG. 3c is a cross sectional view illustrating an embodiment of the battery of FIGS. 3a and 3b.

FIG. 4a is a flow chart illustrating an embodiment of a method for coupling a battery to a system.

FIG. 4b is a perspective view illustrating an embodiment of the battery of FIGS. 3a, 3b, and 3c being coupled to the IHS of FIG. 2.

FIG. 4c is a perspective view illustrating an embodiment of the battery of FIGS. 3a, 3b, and 3c coupled to the IHS of FIG. 2.

FIG. 4d is a cross sectional view illustrating an embodiment of the battery of FIGS. 3a, 3b, and 3c coupled to the IHS of FIG. 2.

FIG. 5 is a cross sectional view illustrating an embodiment of a battery.

FIG. 6 is a cut-away top view illustrating an embodiment of an IHS used with the battery of FIG. 5.

FIG. 7 is a cut-away and cross sectional view illustrating an embodiment of the battery of FIG. 5 coupled to the IHS of FIG. 6.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

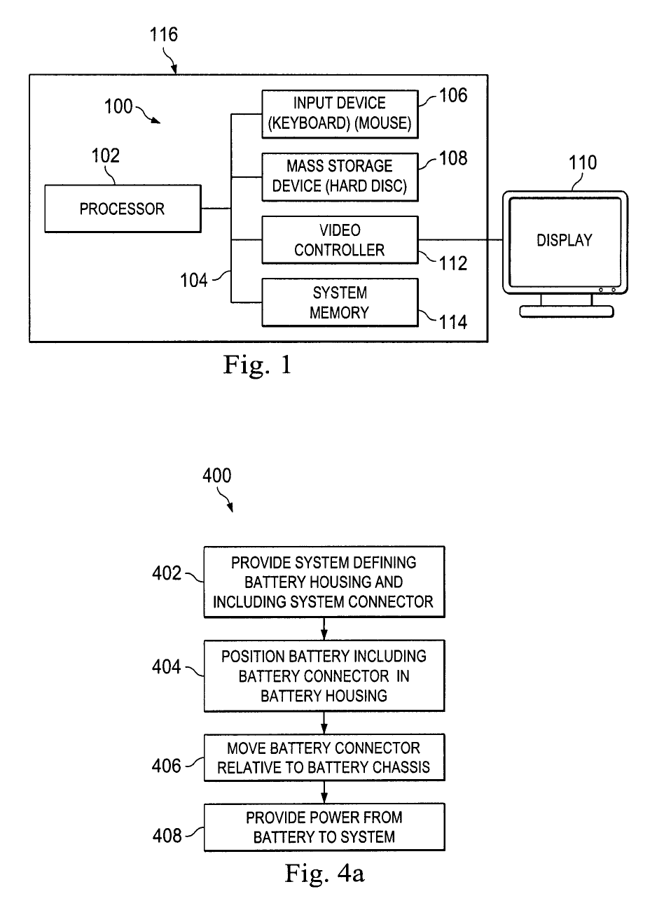

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

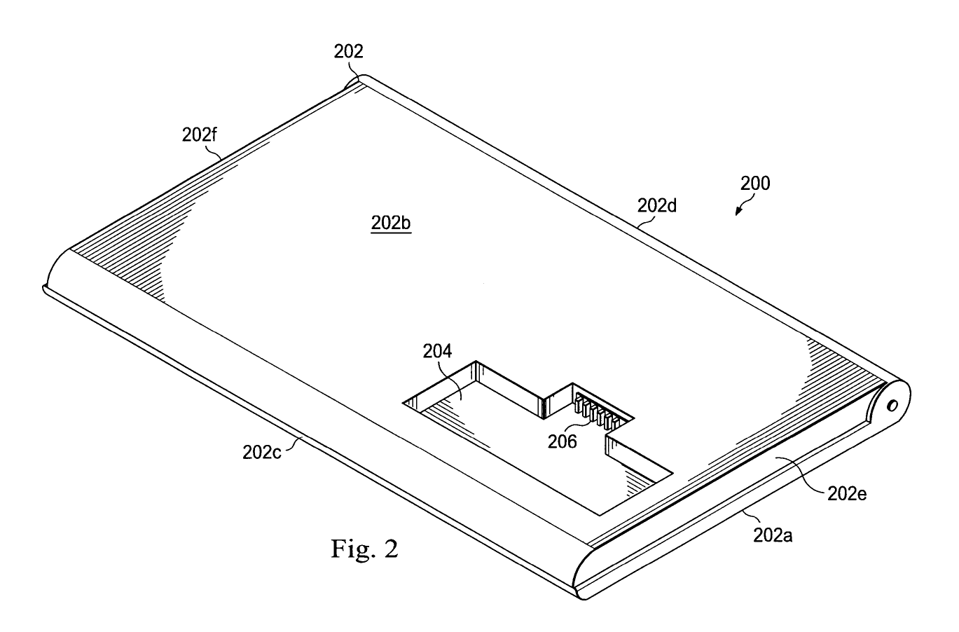

Referring now to FIG. 2, an IHS 200 is illustrated. In an embodiment, the IHS 200 may be, for example, the IHS 100 described above with reference to FIG. 1, and may house some or all of the components of the IHS 100. The IHS 200 includes an IHS chassis 202 having a top surface 202a, a bottom surface 202b located opposite the top surface 202a, a front surface 202c extending between the top surface 202a and the bottom surface 202b, a rear surface 202d located opposite the front surface 202c and extending between the top surface 202a and the bottom surface 202b, and a pair of opposing side surfaces 202e and 202f extending between the top surface 202a, the bottom surface 202b, the front surface 202c, and the rear surface 202d. The IHS chassis 202 defines a battery housing 204 that extends into the IHS chassis 202 from the bottom surface 202b and is located adjacent the front surface 202c and the side edge 202e. An IHS connector 206 is located on the IHS chassis 202 and may be electrically coupled to components in the IHS 200 such as, for example, the processor 102 described above with reference to FIG. 1. In the illustrated embodiment, the IHS connector 206 is located adjacent the battery housing 204 and extends into the battery housing 204. However, one of skill in the art will recognize that the IHS connector 206 may be located in a variety of positions on the IHS chassis 202 such as, for example, adjacent the battery housing 204 but recessed into the IHS chassis 202.

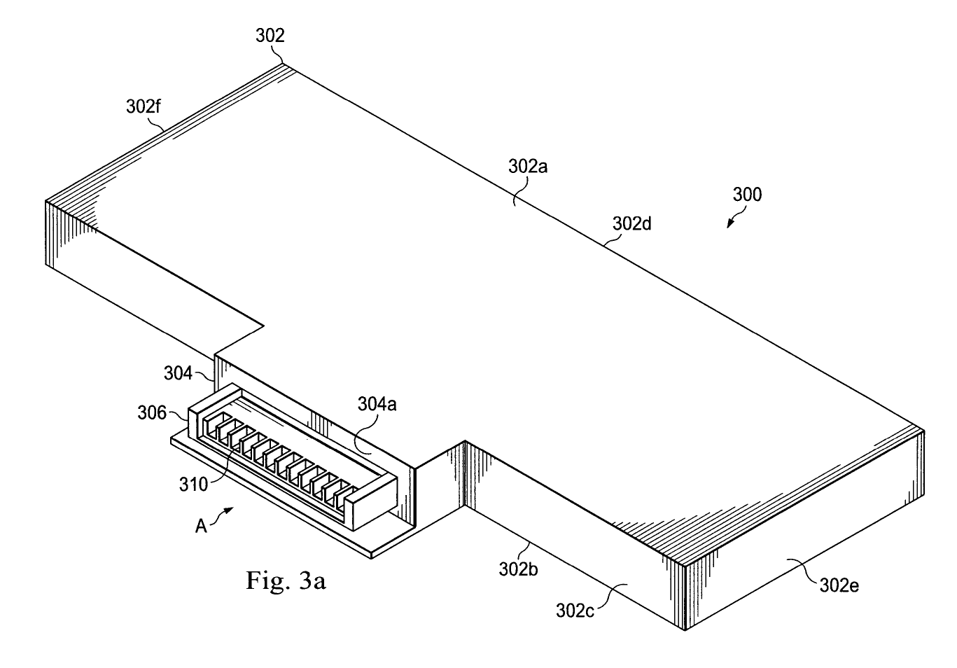

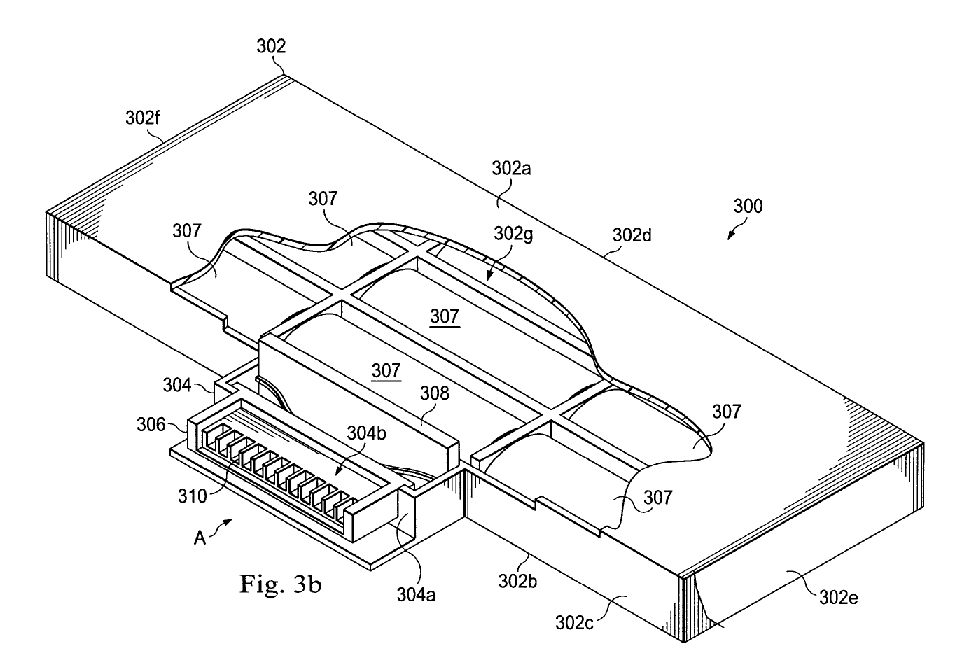

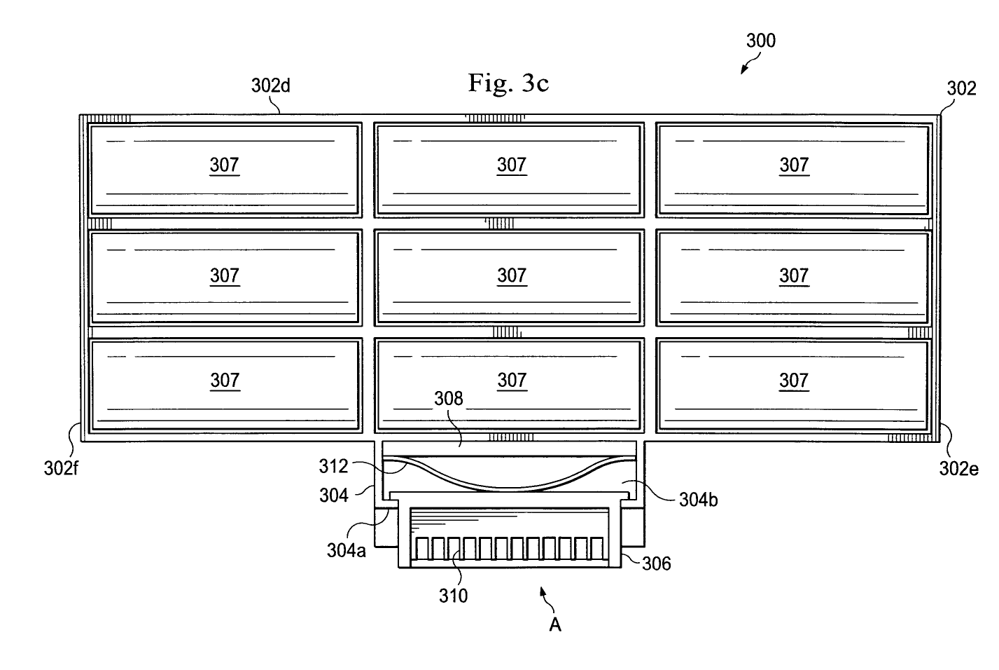

Referring now to FIGS. 3a, 3b, and 3c, a battery 300 is illustrated. The battery 300 includes a battery chassis 302 having a top surface 302a, a bottom surface 302b located opposite the top surface 302a, a front surface 302c extending between the top surface 302a and the bottom surface 302b, a rear surface 302d located opposite the front surface 302c and extending between the top surface 302a and the bottom surface 302b, and a pair of opposing side surfaces 302e and 302f extending between the top surface 302a, the bottom surface 302b, the front surface 302c, and the rear surface 302d. A battery housing 302g is defined by the battery chassis 302 between the top surface 302a, the bottom surface 302b, the front surface 302c, the rear surface 302d, and the sides surfaces 302e and 302f. A connector chassis 304 extends from and is substantially centrally located on the front surface 302c of the battery chassis 302. The connector chassis 304 includes a front surface 304a and defines a connector housing 304b that is located immediately adjacent the battery housing 302g defined by the battery chassis 302. A guide member 306 includes an aperture defined by the connector chassis 304 and extending through the front surface 304a to the connector housing 304b. While the guide member 306 has been described as an aperture defined by the connector chassis 304, the guide member 306 may also include tracks or channels defined by the connector chasis 304 and/or other structural members whose function will be described below. A plurality of battery cells 307 are located in the battery housing 302g and may be electrically coupled to each other. A board 308 which may be, for example, a printed circuit board, is electrically coupled to the battery cells 307. A battery connector 310 is coupled to the board 308 by a resilient member 312. In an embodiment, the resilient member may be, for example, a leaf spring, a coil spring, a rubber material, and/or a variety of other resilient members know in the art. In an embodiment, the battery connector 310 is electrically coupled to the board 308 (and hence, to the battery cells 207) by the resilient member 312. However, in an embodiment, the battery connector 310 may be coupled to the board 308 by a cable, or may be coupled directly to the battery cells 307 using methods known in the art. In the embodiment illustrated in FIGS. 3a, 3b, and 3c, no outside force is acting on the battery connector 310 and the resilient member 312 biases the battery connector 310 into an orientation A such that a portion of the battery connector 310 extends out of the connector housing 304b through the guide member 304a and from the front surface 304a of the connector chassis 304. In an embodiment, the resilient member 310 and/or the guide member 306 provide a battery connector coupling.

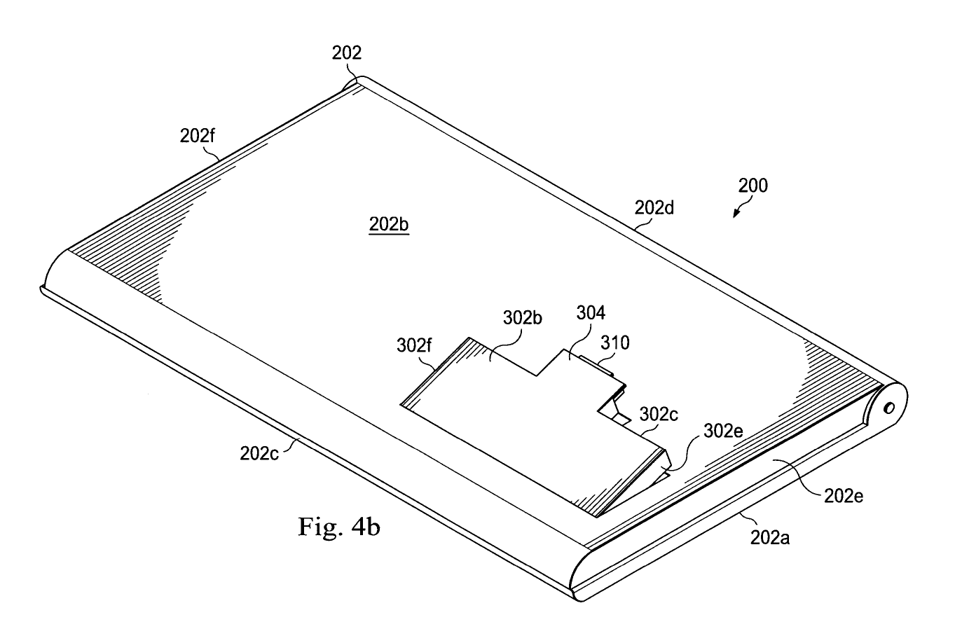

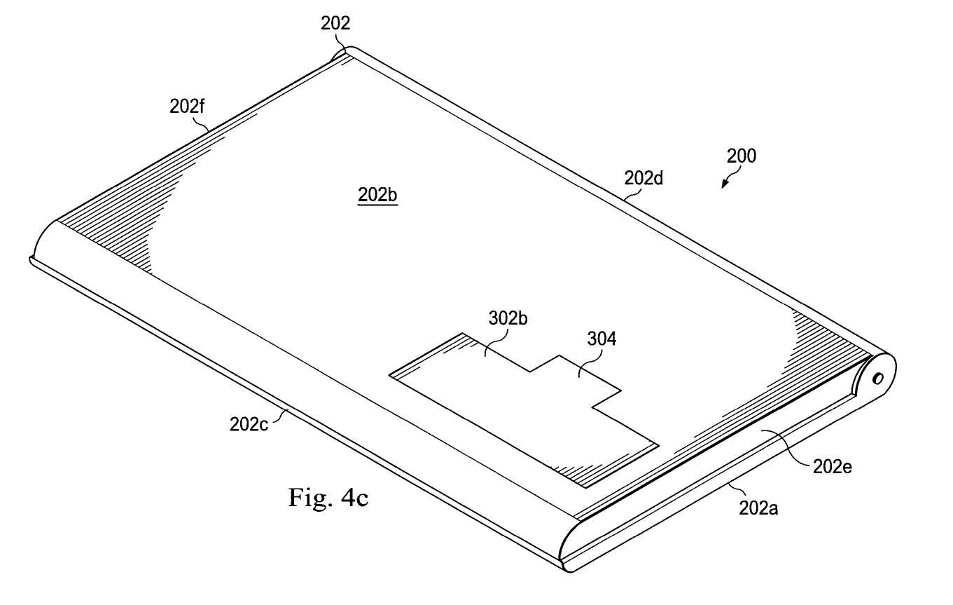

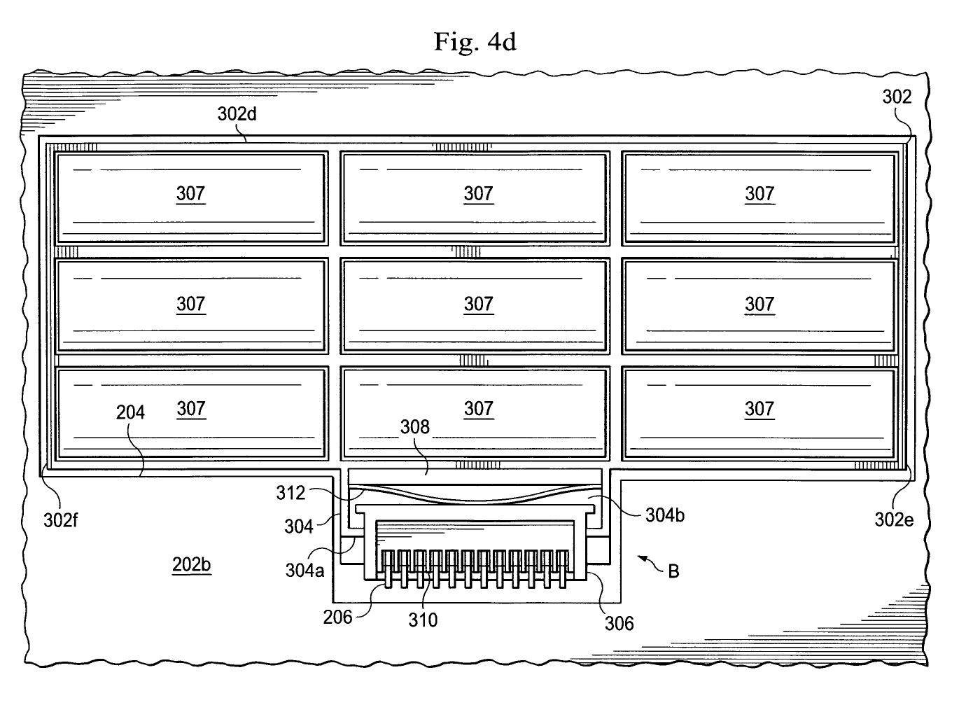

Referring now to FIGS. 2, 3a, 3b, 3c, 4a, 4b, 4c, and 4d, a method 400 for coupling a battery to a system is illustrated. The method 400 begins at block 402 where a system defining a battery housing and including a system connector is provided. In an embodiment, the IHS 200 defining the battery housing 204 and including the IHS connector 206 are provided. The method 400 then proceeds to block 404 where a battery including a battery connector is positioned in the battery housing. The battery 300 is positioned adjacent the IHS 200 such that that the top surface 302a of the battery chassis 302 is located adjacent the battery housing 204 defined by the IHS chassis 202, with the battery connector 310 located adjacent the IHS connector 206. The battery 300 may then be positioned in the battery housing 204 by, for example, positioning the portion of the battery 300 adjacent the rear surface 302d in the battery housing 204, as illustrated in FIG. 4b. In an embodiment, the battery 300 and/or the IHS 200 may include latches or other members in order to secure the battery 300 to the IHS 200.

The method 400 then proceeds to block 406 where the battery connector is moved relative to the battery chassis. From the position illustrated in FIG. 4b, the rest of the battery 300 may be positioned in the battery housing 204 by moving the portion of the battery 300 adjacent the front surface 302c of the battery 300 into the battery housing 204, as illustrated in FIG. 4c. With the battery 300 positioned outside of the battery housing 204, the battery connector 310 is positioned in the orientation A, illustrated in FIG. 3c, due to the resilient member 312 applying a force on the battery connector 310 that causes a portion of the battery connector 310 to extend out of the connector housing 304b through the guide member 304a and past the front surface 304a of the connector chassis 304. When the connector chassis 304 of the battery 300 moves into the battery housing 204, the battery connector 310 engages the IHS connector 206 and the IHS connector 206 applies a force on the battery connector 310. The force on the battery connector 310 causes the resilient member 312 to compress such that the battery connector 310 moves relative to the connector chassis 304 and the battery chassis 302 and a portion of the battery connector 310 that extended past the front surface 304a of the connector chassis 304 to become housed in the connector housing 304b, as illustrated in FIG. 4d. Furthermore, the guide member 306 operates during the movement of the battery connector 310 to guide the battery connector 310 along a predetermined path. The method 400 then proceeds to block 408 where power is provided from the battery to the system. Engagement of the battery connector 310 and the IHS connector 206 provides an electrical coupling between the battery cells 307 and the IHS components (through the electrical coupling of the battery cells 307, the board 308, and the battery connector 310, the engagement of the battery connector 310 and the IHS connector 206, and the electrical coupling of the IHS connector 206 and the IHS components) such that the battery 300 may provide power to the IHS 200. Furthermore, if a shock/vibration event is provided to the IHS 200, power provided from the battery 300 to the IHS 200 will continue to be provided due the resilient member 312 allowing the battery connector 310 to move relative to the connector chassis 304 and the battery chassis 302 during the shock/vibration event and maintain engagement with the IHS connector 206. Thus, a system and method have been described that includes a battery connector coupling that provides continuous engagement of a battery connector and a system connector in order to, for example, provide power during a shock/vibration event when conventional battery connector couplings would allow the battery connector and the system connector to become disengaged.

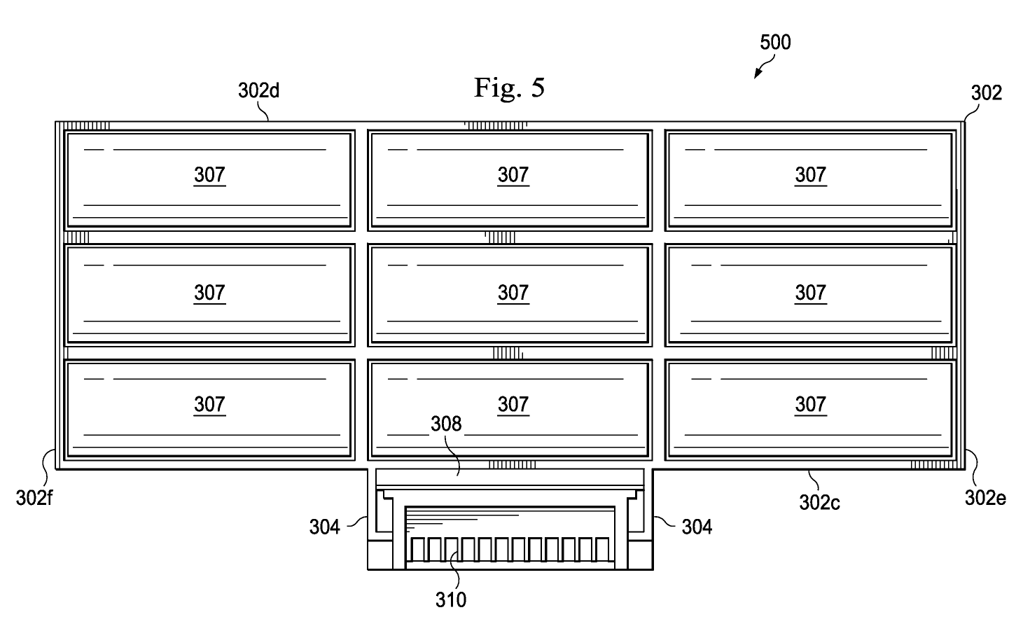

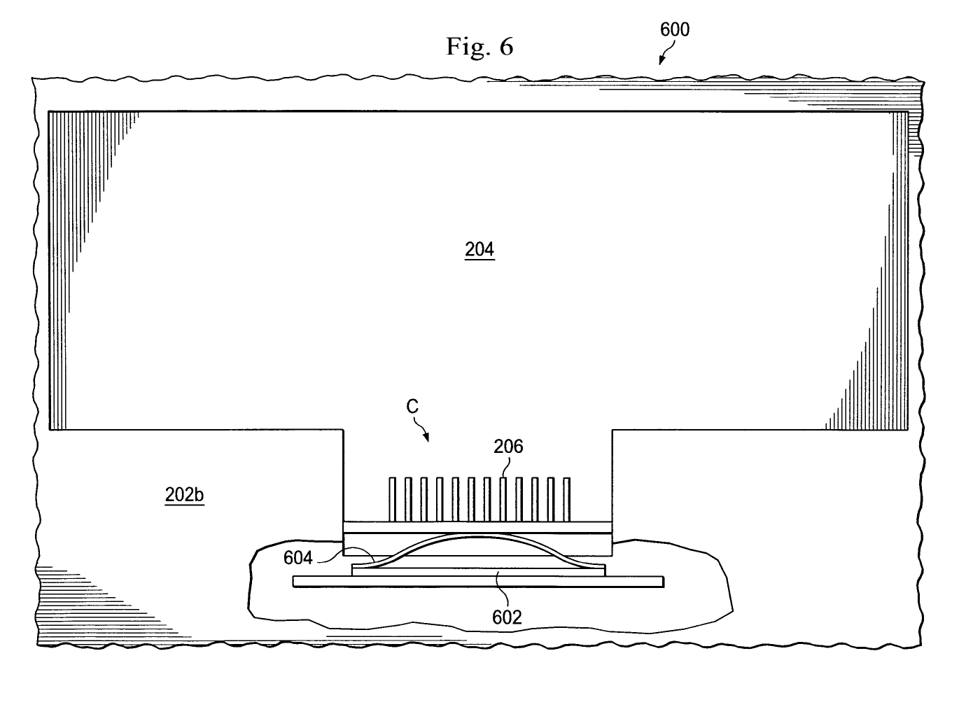

Referring now to FIG. 5, a battery 500 is illustrated that is substantially similar in structure and operation to the battery 300, described above with reference to FIGS. 3a, 3b, and 3c, with the removal of the resilient member 312 such that the battery connector 310 is no longer moveable relative to the battery chassis 302. In the illustrated embodiment, the battery connector 310 may be rigidly mounted to the board 308 and/or other components of the battery 500.

Referring now to FIG. 6, an IHS 600 is illustrated that is substantially similar in structure and operation to the IHS 200, described above with reference to FIG. 2, with the provision of a IHS chassis member 602 and a resilient member 604 that couples the IHS connector 206 to the IHS chassis 202. In an embodiment, the resilient member may be, for example, a leaf spring, a coil spring, a rubber material, and/or a variety of other resilient members know in the art. In an embodiment, the IHS connector 206 is electrically coupled to the IHS chassis member 602 and/or various IHS components by the resilient member 604. However, in an embodiment, the IHS connector 206 may be coupled to the IHS chassis member 602 and/or various IHS components by a cable or using other methods known in the art. In the embodiment illustrated in FIG. 6, no outside force is acting on the IHS connector 206 and the resilient member 602 biases the IHS connector 206 into an orientation C such that the IHS connector 206 extends into the battery housing 204. In an embodiment, the resilient member 602 provides a battery connector coupling.

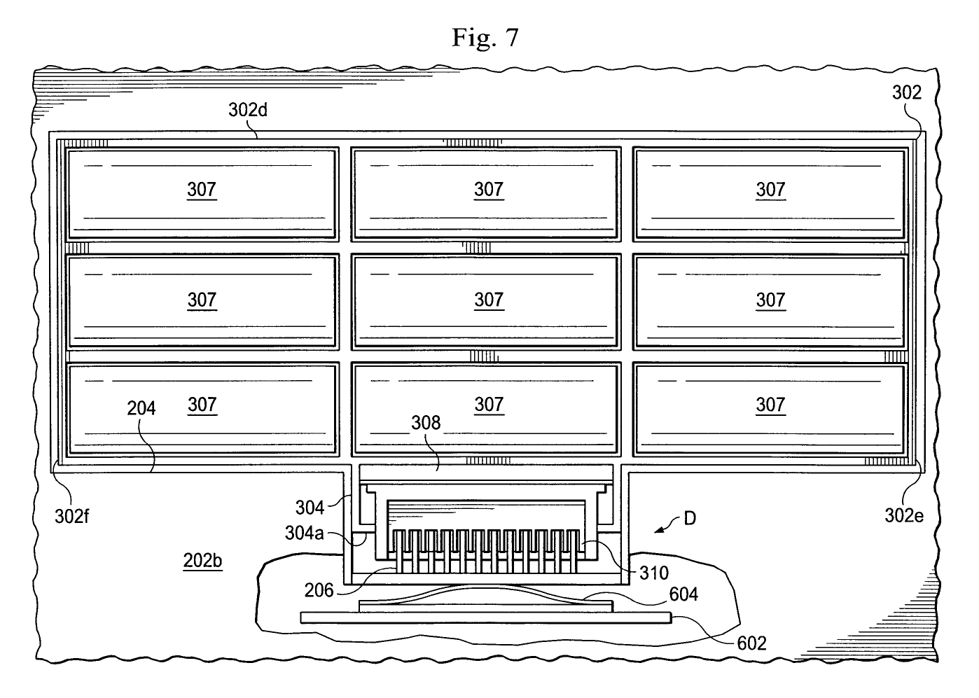

Referring now to FIGS. 4a, 5, 6, and 7, the battery 500 and the IHS 600 may replace the battery 300 and the IHS 200, respectively, in the method 400 by modifying block 406. The battery 500 may be positioned in the battery housing 204 defined by the IHS 600 substantially as described above for the battery 300 and the IHS 200. With the battery 300 positioned outside of the battery housing 204, the IHS connector 206 is positioned in the orientation C, illustrated in FIG. 6, due to the resilient member 604 applying a force on the IHS connector 206 that causes the IHS connector 206 to extend into the battery housing 204. When the connector chassis 304 of the battery 500 moves into the battery housing 204, the battery connector 310 engages the IHS connector 206 and the battery connector 310 applies a force on the IHS connector 206. The force on the IHS connector 206 causes the resilient member 604 to compress such that the IHS connector 206 moves relative to the IHS chassis 202 and into an orientation D that is out of the battery housing 204, as illustrated in FIG. 4d. The method 400 then proceeds to block 408 where power is provided from the battery to the system. Engagement of the battery connector 310 and the IHS connector 206 provides an electrical coupling between the battery cells 307 and the IHS components (through the electrical coupling of the battery cells 307, the board 308, and the battery connector 310, the engagement of the battery connector 310 and the IHS connector 206, and the electrical coupling of the IHS connector 206 and the IHS components) such that the battery 300 may provide power to the IHS 200. Furthermore, if a shock/vibration event is provided to the IHS 600, power provided from the battery 500 to the IHS 600 will continue to be provided due the resilient member 604 allowing the IHS connector 206 to move relative to the IHS chassis 202 during the shock/vibration event and maintain engagement with the battery connector 310. Thus, a system and method have been described that includes a battery connector coupling that provides continuous engagement of a battery connector and a system connector in order to, for example, provide power during a shock/vibration event when conventional battery connector couplings would allow the battery connector and the system connector to become disengaged.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A battery, comprising:
a battery chassis housing at least one battery cell; and
a battery connector electrically coupled to the at least one battery cell and moveably coupled to the battery chassis through a battery connector coupling, wherein the battery connector coupling is operable to allow the battery connector to move relative to the battery chassis while maintaining the electrical coupling between the battery connector and the at least one battery cell.

2. The battery of claim 1, wherein the battery chassis houses a plurality of battery cells that are each electrically coupled to the battery connector.

3. The battery of claim 1, wherein the battery connector coupling comprises a resilient member that biases the battery connector such that the battery connector extends past a surface of the battery chassis.

4. The battery of claim 3, wherein the resilient member is operable to be compressed, in response to a force being applied to the battery connector to move the battery connector relative to the battery chassis, such that at least a portion of the battery connector that extended past the surface of the battery chassis becomes housed in the battery chassis.

5. The battery of claim 1, wherein the battery connector is electrically coupled to a board that is located in the battery chassis, and wherein the board is electrically coupled to the at least one battery cell.

6. The battery of claim 5, wherein the battery connector coupling electrically couples the battery connector to the board.

7. The battery of claim 1, wherein the battery connector coupling comprises at least one guide member that is operable to guide the battery connector along a predetermined path when the battery connector moves relative to the battery chassis.

8. An information handling system (IHS), comprising:
an IHS chassis comprising a processor and defining a battery housing;
an IHS connector located adjacent the battery housing and electrically coupled to the processor;
a battery located in the battery housing and comprising a battery chassis that houses at least one battery cell; and
a battery connector electrically coupled to the at least one battery cell and engaging the IHS connector, wherein the battery connector is moveably coupled to the battery chassis through a battery connector coupling that allows the battery connector to move relative to the battery chassis when the battery connector engages the IHS connector.

9. The IHS of claim 8, wherein the battery chassis houses a plurality of battery cells that are each electrically coupled to the battery connector.

10. The IHS of claim 8, wherein the battery connector coupling comprises a resilient member that biases the battery connector such that the battery connector extends past a surface of the battery chassis and into engagement with the IHS connector.

11. The IHS of claim 10, wherein the resilient member is operable to be compressed, in response to a force being applied to the battery connector by the IHS connector, such that the battery connector moves relative to the battery chassis and at least a portion of the battery connector that extended past the surface of the battery chassis becomes housed in the battery chassis.

12. The IHS of claim 8, wherein the battery connector is electrically coupled to a board that is located in the battery chassis, and wherein the board is electrically coupled to the at least one battery cell.

13. The IHS of claim 12, wherein the battery connector coupling electrically couples the battery connector to the board.

14. The IHS of claim 8, wherein the battery connector coupling comprises at least one guide member that is operable to guide the battery connector along a predetermined path when the battery connector moves relative to the battery chassis.

15. A method for coupling a battery to a system, comprising:
providing a system defining a battery housing and comprising a system connector located adjacent the battery housing;
positioning a battery that comprises a battery chassis and a battery connector in the battery housing; and
moving the battery connector relative to the battery chassis in response to the engagement of the battery connector and the system connector.

16. The method of claim 15, wherein the moving the battery connector comprises compressing a resilient member that is located between the battery connector and the battery chassis by applying a force to the battery connector from the system connector.

17. The method of claim 15, wherein the moving the battery connector comprises applying a force to the battery connector with a resilient member that is located between the battery connector and the battery chassis.

18. The method of claim 15, wherein the moving the battery connector comprises guiding the battery connector along a predetermined path.

19. The method of claim 15, further comprising:
providing power from the battery to the system in response to the engagement of the battery connector and the system connector.

20. The method of claim 19, further comprising:
providing a shock event to the system, wherein the power provided from the battery to the system continues to be provided in response to the continued engagement of the battery connector and the system connector that occurs due to the movement of the battery connector relative to the battery chassis during the shock event.
